(19) United States
(12) Patent Application Publication
(10) Pub. No.: US 2025/0303799 A1
(43) Pub. Date: Oct. 2, 2025

(54) MOTORCYCLE TYRE

(71) Applicant: Pirelli Tyre S.p.A., Milano (IT)

(72) Inventors: Giuliano BONACCORSI, Milano (IT); Matteo TORCHIANA, Milano (IT); Rocco PARENTE, Milano (IT); Luca NAPOLITANO, Milano (IT)

(73) Assignee: Pirelli Tyre S.p.A., Milano (IT)

(21) Appl. No.: 18/866,704

(22) PCT Filed: May 24, 2023
(86) PCT No.: PCT/IB2023/055324

§ 371 Date: Nov. 18, 2024

(30) Foreign Application Priority Data
May 25, 2022 (IT) 102022000010961

(51) Int. Cl. B60C 11/00; B60C 1/00

(52) U.S. Cl. CPC B60C 11/0058; B60C 11/0008; B60C 2001/0083; B60C 2011/0025; B60C 11/0083; B60C 2200/10

(57) ABSTRACT

A tyre (1) for motorcycle wheels is described comprising a tread band (8) of the “cap-and-base” type comprising a radially outer portion, formed by a central sub-portion (11a) made with a first vulcanized elastomeric material and by a pair of lateral sub-portions (11b, 11c) made with a second vulcanized elastomeric material, and a radially inner portion (12) made with a third vulcanized elastomeric material. The first vulcanized elastomeric material of the central sub-portion (11a) has a dynamic elastic modulus (E′) measured at a frequency of 10 Hz and at 23° C. greater than the dynamic elastic modulus (E′) measured in the same conditions of the second vulcanized elastomeric material of the lateral sub-portions (11b, 11c) and both such vulcanized elastomeric materials have a respective dynamic elastic modulus (E′), again measured at a frequency of 10 Hz and at 23° C., comprised between 5.2 and 6.5 MPa and greater than the dynamic elastic modulus (E′) of the third vulcanized elastomeric material, measured in the same conditions. In the tyre (1), the ratios R1 and R2 between the dynamic elastic modulus and the tandelta of the second vulcanized elastomeric material of the lateral sub-portions (11b, 11c) of the radially outer portion and the dynamic elastic modulus and the tandelta of the third vulcanized elastomeric material of the radially inner portion (12) of the tread band (8), respectively measured at a frequency of 10 Hz and at 100° C. and at a frequency of 10 Hz and at 70° C., are comprised between 0.8 and 1.2.

### FIELD OF THE INVENTION

The present invention refers to a motorcycle tyre.

In particular, the present invention relates to a motorcycle tyre for “Supersport” and/or “Hypersport” motorcycles, of large displacement (for example 600 or 1000 cm³ or more), and/or high power (for example 200 horsepower or more), also used on a race track.

Even more particularly, the present invention relates to a high-performance tyre intended for mounting on the rear wheel of motorcycles, in other words a tyre capable of sustaining maximum speeds of at least about 210 km/h or withstanding maximum loads of at least about 210 kg or a combination of both.

### RELATED ART

Motorcycle tyres are known for example from EP 2 662 226 A1 and from WO 2019/082012.

### SUMMARY OF THE INVENTION

Recently, it has been observed that there is a tendency to introduce into the market high-powered motorcycles for Supersport or Hypersport use. Indeed, there are on the market, for example, road motorcycles of 1000 cm³ displacement and more, with powers of 200 horsepower or even more.

The Applicant has noted an increasing demand for use of such supersport motorcycles, both on road and on a race track.

In parallel, the Applicant has noted an increasing demand for high-performance tyres both for highly-demanding sports driving (for example to be accomplished on a race track), and in terms of lifetime and handling in any atmospheric and seasonal condition (for road use of the motorcycle throughout the year).

In this concern, the Applicant has in particular observed a recent trend of the users wishing to find in the tyres mounted in Supersport motorcycles, a handling performance and a performance in conditions of extreme speed and maneuvers on dry and/or hot ground (hereinafter also indicated as “hot” use conditions) together with handling performance and road holding in wet and/or cold climatic conditions or in non-optimal road surface conditions (hereinafter also indicated as “cold” use conditions) and, this, keeping tyre performance as constant as possible over time.

Satisfying such mutually contrasting requirements with a single pair of tyres is a particularly demanding task insofar as a different intervention is typically adopted for each of the above requirements, applying solutions suited for the specific problem, but in contrast with the others.

In order to improve the handling performance and performance on dry and/or hot ground, as well as in wet and/or in cold climatic conditions or on a non-optimal road surface, it is necessary in particular to ensure optimal grip to the ground in these different driving conditions.

In order to improve the grip of the tyre it is possible to use, when manufacturing the tread band, vulcanized elastomeric materials (also defined with the term “rubber compounds” in the present document) of the so-called soft kind, which better adapt to the roughness of the road surface copying the irregular profile thereof. These vulcanized elastomeric materials are typically characterized by a low elastic modulus and/or high hysteresis.

The Applicant has however observed that rubber compounds that are too soft result in a decrease in driving stability traveling along a straight course and a decrease in the tyre lifetime.

In order to overcome the aforementioned problems, tyres with tread bands made with different rubber compounds have been proposed. Typically, a softer rubber compound at the shoulder and a less soft rubber compound at the crown.

Tyres thus configured are for example described in EP 2 662 226.

In relation to this configuration of the tread band, the Applicant has however observed that the handling performance and performance of the tyre in “hot” use conditions tend to degrade, in particular in the case of extreme use, such as for example on a race track, significantly impairing the useful life of the tyre.

In order to try to meet the aforementioned contrasting requirements with a single pair of tyres, tyres have also been proposed with tread bands made with different rubber compounds, typically, a rubber compound with a higher content of a carbon black filler at the shoulder portions and several rubber compounds with a higher content of white fillers at the crown and at the intermediate annular portions of the tread band, all in combination with a suitable distribution and positioning of the grooves of the tread band at the interface between rubber compounds of different composition, as described, for example, in WO 2019/082012 in the name of the Applicant.

Finally, the Applicant has observed that rigid tyre structures, typical for use on a race track where tyres are deflated by many tenths of a bar with respect to the pressure recommended by the manufacturer to have a greater ground-contacting area so as to be able to have an adequate readiness to extreme maneuvers seem not very appropriate for road use in which the tyre inflated to the pressure recommended by the manufacturer is required to provide comfort, road holding and ability to absorb stresses on different road surfaces.

In its search for a constant improvement of motorcycle tyres, the Applicant has posed itself the two-fold objective of improving and keeping constant for as long a time as possible the handling performance as well as the tyre performance in “hot” use conditions without penalizing the handling and road holding performance in the aforementioned “cold” use conditions of the tyre.

The Applicant has found that it is possible to achieve such a two-fold objective by adopting a so-called “cap-and-base” configuration of the tread band and by using vulcanized elastomeric materials having suitable dynamic mechanical properties in the “cold” and “hot” use conditions of the tyre.

In particular, the Applicant has found that, to this end, it is necessary to simultaneously adopt the following provisions:
i) using a configuration of the radially outer portion of the tread band of the type comprising a central sub-portion arranged astride of the equatorial plane of the tyre and a pair of lateral sub-portions distal with respect to the equatorial plane of the tyre and arranged on opposite sides of said central sub-portion, and
ii) using vulcanized elastomeric materials having specific dynamic mechanical characteristics in the respective “hot” and “cold” use conditions of the tyre in each portion of the tread band.

In this regard, the Applicant has also found that it is necessary to evaluate the dynamic mechanical characteristics of the vulcanized elastomeric materials used to manufacture the different portions of the tread band in a differentiated manner for each elastomeric material and in the specific stress and temperature conditions that can be correlated to the actual use conditions of each material that is subjected, during use of the tyre, to different types of stress and different temperatures depending on the position thereof in the tread band.

As far as a “cold” use of the tyre is concerned, the Applicant has in particular found that dynamic mechanical characteristics predictive of the tyre behavior in such use conditions are the dynamic elastic modulus E′ and the tandelta measured at a frequency of 10 Hz and at 23° C. for all of the elastomeric materials that form the tread band.

Conversely and as far as a “hot” use of the tyre is concerned, the Applicant has found that dynamic mechanical characteristics predictive of the behavior of the tyre in such use conditions are the dynamic elastic modulus E′ and the tandelta respectively measured:
at a frequency of 10 Hz and at 70° C. for the vulcanized elastomeric material of the central sub-portion of the radially outer portion of the tread band and for the vulcanized elastomeric material of the radially inner portion of the tread band; and
at a frequency of 10 Hz and at 100° C. for the vulcanized elastomeric material of the lateral sub-portions of the radially outer portion of the tread band.

The Applicant has thus found that the desired goal of preserving the handling and road holding performance in the aforementioned “cold” use conditions of the tyre can be achieved by using:
in the central sub-portion of the radially outer portion of the tread band, a first vulcanized elastomeric material having a dynamic elastic modulus E′, measured at a frequency of 10 Hz and at 23° C., greater than that of a second vulcanized elastomeric material used in the lateral sub-portions of the radially outer portion of the tread band, and
in the radially inner portion of the tread band, a third vulcanized elastomeric material having a dynamic elastic modulus E′, measured at a frequency of 10 Hz and at 23° C., lower than that of the aforementioned first and second elastomeric material.

As far as a “hot” use of the tyre is concerned, the Applicant has, on the other hand, found that the desired objective of improving and keeping constant for as long as possible the handling and performance of the tyre can be simultaneously achieved:
by keeping a ratio between the “hot” dynamic elastic modulus (E′) of the second vulcanized elastomeric material used in the lateral sub-portions of the radially outer portion of the tread band and of the third vulcanized elastomeric material used in the radially inner portion of the tread band to values close to one, i.e. by keeping the dynamic elastic modulus (E′) of such materials at values very similar to one another; and
by keeping the ratios between the “hot” tandelta of the second and third vulcanized elastomeric material and the ratios between the “hot” tandelta of the first and third vulcanized elastomeric material to values close to one, i.e. by keeping the tandelta of such materials at values very similar to one another.

The Applicant has surprisingly found that by controlling the modulus and hysteresis values, notably the tandelta values, correlated to the use conditions of the tyre of the vulcanized elastomeric materials used to make the various portions of the tread band within specific ratios depending on the area of the tread band that is considered, the “hot” handling and road holding performance of the tyre can be both improved, and maintained at optimal levels over time without penalizing the handling and road holding performance in the aforementioned “cold” use conditions of the tyre.

In particular, improving and maintaining over time the handling and performance of the tyre in “hot” use conditions have been surprisingly achieved by using, in the radially inner portion of the tread band, a so-called “soft” vulcanized elastomeric material having, both in cold and hot conditions, a lower elastic modulus and a higher hysteresis than those of both the vulcanized elastomeric materials used in the radially outer portion of the tread band.

Improving and maintaining over time the handling and performance of the tyre in “hot” use conditions is surprising since the use in the radially inner portion of the tread band of such a “soft” vulcanized elastomeric material seemed not only poorly suited to provide constant performance over time in such use conditions, but even-on the contrary-prone to cause a rapid performance decay of the tyre.

The invention therefore relates to a motorcycle tyre.

Such a motorcycle tyre comprises an equatorial plane and a tread band comprising:
a) a radially outer portion comprising:
a1) a central sub-portion arranged astride of the equatorial plane of the tyre and made with a first vulcanized elastomeric material, and
a2) a pair of lateral sub-portions, distal with respect to the equatorial plane of the tyre and arranged on opposite sides of said central sub-portion, said lateral sub-portions being made with a second vulcanized elastomeric material;
   wherein the first vulcanized elastomeric material of the central sub-portion has a dynamic elastic modulus (E′) measured at a frequency of 10 Hz and at 23° C. greater than the dynamic elastic modulus (E′) measured at a frequency of 10 Hz and at 23° C. of said second vulcanized elastomeric material of the lateral sub-portions;
   wherein said first vulcanized elastomeric material of the central sub-portion and said second vulcanized elastomeric material of the lateral sub-portions have a respective dynamic elastic modulus (E′) measured at a frequency of 10 Hz and at 23° C. comprised between 5.2 and 6.5 MPa;
b) a radially inner portion extending below the radially outer portion of the tread band and along the entire axial development thereof, the radially inner portion being made with a third vulcanized elastomeric material having a dynamic elastic modulus (E′) measured at a frequency of 10 Hz and at 23° C. lower than the dynamic elastic modulus (E′), measured at a frequency of 10 Hz and at 23° C., of said first vulcanized elastomeric material of the central sub-portion of the radially outer portion of the tread band and of said second vulcanized elastomeric material of the lateral sub-portions of the radially outer portion of the tread band;
wherein a ratio R1 between the dynamic elastic modulus (E′) of the second vulcanized elastomeric material of the lateral sub-portions of the radially outer portion of the tread band, measured at a frequency of 10 Hz and at 100° C., and the dynamic elastic modulus (E′) of the third vulcanized elastomeric material of the radially inner portion of the tread band, measured at a frequency of 10 Hz and at 70° C., is comprised between 0.8 and 1.2; and
wherein a ratio R2 between the tandelta of the second vulcanized elastomeric material of the lateral sub-portions of the radially outer portion of the tread band, measured at a frequency of 10 Hz and at 100° C., and the tandelta of the third vulcanized elastomeric material of the radially inner portion of the tread band, measured at a frequency of 10 Hz and at 70° C., is comprised between 0.8 and 1.2.

The Applicant has experimentally found that by using a tread band of the so-called “cap-and-base” type having the aforementioned characteristics it is surprisingly possible to improve and maintain over time the handling and performance of the tyre in “hot” use conditions of a motorcycle tyre, in particular a “Supersport” and/or “Hypersport” motorcycle tyre, and, this, while keeping the handling and road holding performance in wet and/or in cold climatic conditions or on a non-optimal road surface substantially unchanged.

Without wishing to be bound by any interpretative theory, the Applicant deems that in “hot” use conditions the tyre as defined above has a substantially uniform dynamic and hysteretic behavior of the tread band at the shoulder areas, i.e. in the most stressed areas in such use conditions.

The Applicant has found that this substantially uniform dynamic and hysteretic behavior advantageously limits premature tyre wearing phenomena and degradation of the tyre performance and can be achieved by controlling to values close to one:
i) the ratio between the deformability characteristics—correlated to the values of dynamic elastic modulus (E′) in the respective “hot” use conditions identified above—of the second vulcanized elastomeric material, present in the lateral or shoulder sub-portions of the radially outer portion of the tread band, and of the third vulcanized elastomeric material, present in the radially inner portion of the tread band, and
ii) the ratio between the hysteresis characteristics—correlated to the tandelta values in the respective “hot” use conditions identified above—of the second and of the third vulcanized elastomeric material.

Surprisingly and as outlined above, this advantageous technical effect has been observed by using, in the radially inner portion of the tread band, a third vulcanized elastomeric material having—in the use conditions of the tyre—a lower elastic modulus and a higher tandelta than those of the second vulcanized elastomeric material used in the shoulder area of the radially outer portion of the tread band, characteristics that would have been thought to lead to a rapid performance decay in “hot” use conditions of the tyre that, in fact, did not prove to be the case. Instead, the third vulcanized elastomeric material actually allowed to improve and preserve over time the handling and performance of the tyre in “hot” use conditions.

Conversely and again without wishing to be bound by any interpretative theory, the Applicant deems that in “cold” use conditions of the tyre the third vulcanized elastomeric material present in the radially inner portion of the tread band is subject to deformations (correlated to the elastic modulus E′) and hysteresis phenomena (correlated to the tandelta parameter) that allow to “heat” the overlying radially outer portion of the tread band (stiffer and with less hysteresis), allowing said latter portion to better adhere to the ground in wet and/or cold conditions, thereby obtaining adequate handling and road holding performance in these use conditions.

Basically, in the tyre according to the invention there is an effective convergence of the hysteresis characteristics in the shoulder area of the tread band of the tyre and in “hot” use conditions with an improvement and maintaining over time of the handling and road holding performance in extreme speed and maneuvering conditions on a dry and/or hot ground and, at the same time, an effective differentiation of the characteristics of stiffness and hysteresis between the different portions of the tread band in “cold” use conditions of the tyre, maintaining the handling and road holding performance in wet and/or in cold climatic conditions or on a non-optimal road surface.

In particular, in “hot” use conditions, the assembly formed by the lateral or shoulder sub-portions of the radially outer portion of the tread band and by the part of the radially inner portion of the tread band beneath such sub-portions of the tyre according to the invention behaves, from the deformability and hysteresis viewpoint, as if the assembly would be constituted substantially by a single vulcanized elastomeric material provided with optimal characteristics in these conditions of use.

Advantageously, the tyre according to the invention thus achieves not only improved handling and road holding performance in extreme speed and maneuvering conditions on dry and/or hot surfaces, but it is also capable of maintaining such performance over a longer time.

In “hot” use conditions, moreover, the assembly formed by the central sub-portion of the radially outer portion of the tread band and by the part of the radially inner portion of the tread band beneath such a sub-portion of the tyre according to the invention optimally behaves, from the deformability and hysteresis viewpoint, also in driving conditions along a straight course where it is necessary to dampen as much as possible any irregularities of the road surface.

In the present description and in the following claims, all numerical entities indicating amounts, parameters, percentages and so forth are to be understood as being preceded in all instances by the term “about” unless indicated otherwise. Moreover, all the ranges of numerical entities include all the possible combinations of the maximum and minimum numerical values and all the possible intermediate ranges, in addition to those specifically indicated hereinbelow.

Where not indicated otherwise, all the ranges of numerical entities also include the maximum and minimum numerical values.

For the purposes of the present invention, the following definitions apply.

The term “phr” (an acronym for parts per hundred parts of rubber) indicates the parts by weight of a given component of the elastomeric rubber compound per 100 parts by weight of the elastomeric polymer considered net of any plasticizing extension oils.

The term “elastomeric material”, “rubber”, elastomeric polymer” or “elastomer” is used to indicate a material comprising a vulcanizable natural or synthetic polymer and a reinforcing filler, wherein such a material, at room temperature and after having been subjected to vulcanization, can undergo deformations caused by a force and is capable of quickly and energetically recovering the substantially original shape and size after the elimination of the deforming force (according to the definitions of ASTM standard D1566-11 Standard Terminology Relating To Rubber).

The term “diene polymer” is used to indicate a polymer or copolymer deriving from the polymerization of one or more different monomers, at least one of which is a conjugated diene (conjugated diolefin).

The term “rubber compound” or “elastomeric rubber compound” is used to indicate the mixture that can be obtained by mixing and possibly heating at least one elastomeric polymer with at least one of the additives commonly used in the preparation of rubber compounds for tyres.

The term “vulcanizable rubber compound” or “vulcanizable elastomeric rubber compound” is used to indicate the elastomeric mixture ready for vulcanization, obtainable by incorporating in an elastomeric rubber compound all the additives including the vulcanizing ones.

The term “vulcanized elastomeric material” is used to indicate the material obtainable by vulcanizing a vulcanizable elastomeric rubber compound.

The term “vulcanization” is used to indicate the cross-linking reaction in a natural or synthetic rubber induced by a cross-linking agent, typically sulfur-based.

The term “vulcanizing agent” is used to indicate a compound capable of transforming natural or synthetic rubber into an elastic and strong material thanks to the formation of a three-dimensional lattice of inter- and intra-molecular bonds. Typical vulcanizing agents are sulfur-based compounds such as for example elemental sulfur, polymeric sulfur, sulfur donor agents such as bis [(trialkoxysilyl) propyl] polysulfides, thiurams, dithiodimorpholins and caprolactam-disulfide.

The term “vulcanization accelerant” is used to indicate a compound capable of decreasing the duration of the vulcanization process and/or the operating temperature, such as for example TBBS, sulfenamides in general, thiazoles, dithiophosphates, dithiocarbamates, guanidines, as well as sulfur donors such as thiurams.

The term “vulcanization activator” is used to indicate a compound capable of further facilitating vulcanization, allowing the latter to take place in shorter times and possibly at lower temperatures. An example of activator is the stearic acid-zinc oxide system.

The term “vulcanization retardant” is used to indicate a compound capable of delaying the start of the vulcanization reaction and/or suppressing undesired secondary reactions, for example N-(cyclohexylthio) phthalimide (CTP).

The term “reinforcing filler” is used to indicate a reinforcing material typically used in the field to improve the mechanical properties of tyre rubbers, preferably selected among carbon black and “white filler”.

The term “white filler” is used to indicate a conventional reinforcing material used in the field selected among conventional silica and silicates, such as preferably amorphous silica sand precipitated with strong acids, diatomaceous earth, calcium carbonate, titanium dioxide, talc, alumina, aluminosilicates, kaolin, silicate fibers, phyllosilicates such as sepiolite, palygorskite also known as attapulgite, montmorillonite, halloysite and similar, optionally modified by acid treatment and/or derivatized, and mixtures thereof. Typically, the white fillers have superficial hydroxyl groups.

The term “motorcycle tyre” is used to indicate a tyre having a high curvature ratio (typically greater than 0.20) and capable of reaching high camber angles during cornering.

The term “curvature ratio” is used to indicate the ratio between the distance comprised between the radially highest point of the tread band and the maximum width of a radial section of the tyre (such a distance also being identified as “arrow”), and the same maximum width of the tyre (also called “maximum chord”), in a cross section thereof.

The term “axial development” of the tread band or of portions thereof is used to indicate the development of the radially outermost profile of the tread band or of portions thereof in a cross section of the tyre carried out by means of a plane containing the rotation axis of the tyre.

The term “axial half-development” of the tread pattern, of the tread band or of portions thereof is used to indicate the development, from the equatorial plane and towards an axially outermost end of the tyre, of the radially outermost profile of the tread band or of portions thereof in a cross section of the tyre carried out by means of a plane containing the rotation axis of the tyre.

The term “equatorial plane” of the tyre is used to indicate a plane perpendicular to the rotation axis of the tyre and that divides the tyre into two symmetrically equal parts.

The term “width” is used to indicate a dimension measured along a direction perpendicular to the equatorial plane.

The term “tread pattern” is used to indicate the representation of all of the points of the tread band (grooves included) on a plane perpendicular to the equatorial plane of the tyre and tangent to the maximum diameter of the tyre. The tread pattern is defined by a plurality of land portions separated by grooves and possibly including sipes.

The terms “radial” and “axial” and the expressions “radially inner/outer” and “axially inner/outer” are used by making reference, respectively, to a direction substantially parallel to the equatorial plane of the tyre and to a direction substantially perpendicular to the equatorial plane of the tyre, i.e. to a direction substantially perpendicular to the rotation axis of the tyre and to a direction substantially parallel to the rotation axis of the tyre, respectively.

The terms “circumferential” and “circumferentially” are used by making reference to the direction of circumferential development of the tyre, i.e. to the rolling direction of the tyre, which corresponds to a direction lying on a plane coinciding with or substantially parallel to the equatorial plane of the tyre.

The term “circumferential development” of the tyre, or of the tread band or of portions thereof, is used to indicate the plan development of the radially outermost surface of the tyre, or of the tread band or of portions thereof, on a plane tangent to the tyre.

The expressions “axially innermost” and “axially outermost” indicate a position respectively closer to, and further away from, the equatorial plane with respect to a reference element.

The term “radial carcass structure” is used to indicate a carcass structure comprising a plurality of reinforcing cords each of which is oriented, in a crown portion of the tyre, along a substantially axial direction. Such reinforcing cords can be incorporated in a single carcass ply or in several carcass plies (preferably two) radially superimposed on one another.

The term “substantially axial direction” is used to indicate a direction inclined, with respect to the equatorial plane of the tyre, by an angle comprised between 60° and 90°.

The term “substantially circumferential direction” is used to indicate a direction oriented, with respect to the equatorial plane of the tyre, at an angle comprised between 0° and 20°.

The term “static mechanical properties” of a tread rubber compound is used to indicate the stress-strain properties under traction of vulcanized and thermoplastic rubbers according to UNI standard 6065:2001 measured at a predetermined temperature on samples of the vulcanized rubber compound at 170° C. for 10 minutes.

The term “dynamic mechanical properties” of a tread rubber compound is used to indicate mechanical properties measured using an Instron dynamic device model 1341 in traction-compression mode as described herein.

A test piece of cross-linked material (170° C. for 15 minutes) was used having a cylindrical shape (length=25 mm; diameter=18 mm), preloaded under compression up to a longitudinal deformation of 25% with respect to the initial length and kept at a predetermined temperature (for example 23° C., 70° C. and 100° C.) for the entire duration of the test. After a wait time of 2 minutes followed by a mechanical pre-conditioning of 125 cycles at 10 Hz at 7.5% deformation amplitude with respect to the length under preload, the test piece was subjected to a dynamic sinusoidal stress having an amplitude of +3.5% with respect to the length under preload, with a predetermined frequency for example of 10 Hz. The dynamic mechanical properties are expressed in terms of values of elastic dynamic modulus (E′) and tandelta (loss factor). The tandelta value was calculated as the ratio between the viscous dynamic modulus (E″) and the elastic dynamic modulus (E′).

The present invention can, in one or more of the aforementioned aspects, have one or more of the preferred features given hereinafter, which can be combined as desired according to the application requirements.

Preferably, the first vulcanized elastomeric material of the central sub-portion and the second vulcanized elastomeric material of the lateral sub-portions of the radially outer portion of the tread band have a respective dynamic elastic modulus (E′) measured at a frequency of 10 Hz and at 23° C. comprised between 5.8 and 6.4 MPa.

In this way, it is advantageously possible to have adequate stiffness characteristics of the tread band in “cold” use conditions of the tyre.

Preferably, the ratio R1 between the dynamic elastic modulus (E′) of the second vulcanized elastomeric material of the lateral sub-portions of the radially outer portion of the tread band, measured at a frequency of 10 Hz and at 100° C., and the dynamic elastic modulus (E′) of the third vulcanized elastomeric material of the radially inner portion of the tread band, measured at a frequency of 10 Hz and at 70° C., is comprised between 0.9 and 1.1.

Advantageously, this preferred feature contributes to optimize and keep substantially constant over time the handling and performance of the tyre in extreme speed and maneuvering conditions on dry and/or hot surfaces during cornering, since the shoulder area of the tread band of the tyre is formed, from the viewpoint of its “hot” deformation capability, by a vulcanized elastomeric material that is substantially “homogeneous” from the viewpoint of its behavior on the road.

Preferably, the ratio R2 between the tandelta of the second vulcanized elastomeric material of the lateral sub-portions of the radially outer portion of the tread band, measured at a frequency of 10 Hz and at 100° C., and the tandelta of the third vulcanized elastomeric material of the radially inner portion of the tread band, measured at a frequency of 10 Hz and at 70° C., is comprised between 0.9 and 1.1.

Also in this case, this preferred feature advantageously contributes to optimize and keep substantially constant over time the handling and performance of the tyre in extreme speed and maneuvering conditions on dry and/or hot surfaces during cornering, since the shoulder area of the tread band of the tyre is formed, from the viewpoint of its “hot” deformation capability, by a vulcanized elastomeric material that is substantially “homogeneous” from the viewpoint of its behavior on the road.

Preferably, the first vulcanized elastomeric material of the central sub-portion of the radially outer portion of the tread band has a dynamic elastic modulus (E′), measured at a frequency of 10 Hz and at 70° C., comprised between 5.1 and 5.5 MPa and, more preferably, comprised between 5.2 and 5.4 MPa.

Preferably, the first vulcanized elastomeric material of the central sub-portion of the radially outer portion of the tread band has a tandelta, measured at a frequency of 10 Hz and at 70° C., comprised between 0.26 and 0.30, and, more preferably, comprised between 0.27 and 0.29.

Preferably, the second vulcanized elastomeric material of the lateral sub-portions of the radially outer portion of the tread band has dynamic elastic modulus (E′), measured at a frequency of 10 Hz and at 100° C., comprised between 2.5 and 2.9 MPa and, more preferably, comprised between 2.6 and 2.8 MPa.

Advantageously, this preferred feature contributes to achieve an optimal ground-contacting performance and an optimal grip of the tyre on the ground so as to improve the handling and performance of the tyre in “hot” use conditions.

Preferably, the second vulcanized elastomeric material of the lateral sub-portions of the radially outer portion of the tread band has a tandelta, measured at a frequency of 10 Hz and at 100° C., comprised between 0.24 and 0.28 and, more preferably, comprised between 0.25 and 0.27.

Also in this case, this preferred feature advantageously contributes to achieve an optimal ground-contacting performance and an optimal grip of the tyre on the ground so as to improve the handling and performance of the tyre in “hot” use conditions.

Preferably, the third vulcanized elastomeric material of the radially inner portion of the tread band has dynamic elastic modulus (E′), measured at a frequency of 10 Hz and at 70° C., comprised between 2.5 and 2.9 MPa and, more preferably, comprised between 2.6 and 2.8 MPa.

Advantageously, this preferred feature allows the third vulcanized elastomeric material of the radially inner portion of the tread band to effectively contribute to achieve optimal handling and performance of the tyre in “hot” use conditions.

In such “hot” use conditions, in fact, the third vulcanized elastomeric material of the radially inner portion of the tread band simultaneously possesses characteristics of deformability, correlated to the values of the dynamic elastic modulus (E′), suitably differentiated in the various areas of the tread band and capable to achieve characteristics of high stability from the dynamic point of view of the tread band as a whole in “hot” use conditions.

The third vulcanized elastomeric material, in fact, possesses deformability characteristics substantially identical to those of the second vulcanized elastomeric material of the shoulder sub-portions of the radially outer portion of the tread band and much lower than those of the first vulcanized elastomeric material of the central portion of the radially outer portion of the tread band, thereby allowing to “mimick” the hysteresis behavior of the shoulder portions and to “heat” the central sub-portion of the tread band formed by a less deformable rubber compound.

Preferably, the third vulcanized elastomeric material of the radially inner portion of the tread band has a tandelta, measured at a frequency of 10 Hz and at 70° C., comprised between 0.25 and 0.29 and, more preferably, comprised between 0.26 and 0.28.

Advantageously, also this preferred feature allows the third vulcanized elastomeric material of the radially inner portion of the tread band to effectively contribute to achieve optimal handling and performance of the tyre in “hot” use conditions, in this case having hysteresis characteristics, correlated to the tandelta values, substantially identical to those of the first and second vulcanized elastomeric material of the radially outer portion of the tread band.

Preferably, the first vulcanized elastomeric material of the central sub-portion of the radially outer portion of the tread band has a dynamic elastic modulus (E′), measured at a frequency of 10 Hz and at 23° C., comprised between 6.0 and 6.5 MPa and, more preferably, comprised between 6.2 and 6.4 MPa.

Preferably, the first vulcanized elastomeric material of the central sub-portion of the radially outer portion of the tread band has a tandelta, measured at a frequency of 10 Hz and at 23° C., comprised between 0.40 and 0.44, and, more preferably, comprised between 0.41 and 0.43.

Preferably, the second vulcanized elastomeric material of the lateral sub-portions of the radially outer portion of the tread band has a dynamic elastic modulus (E′), measured at a frequency of 10 Hz and at 23° C., comprised between 5.5 and 6.0 MPa and, more preferably, comprised between 5.7 and 5.9 MPa.

Preferably, the second vulcanized elastomeric material of the lateral sub-portions of the radially outer portion of the tread band has a tandelta, measured at a frequency of 10 Hz and at 23° C., comprised between 0.66 and 0.70 and, more preferably, comprised between 0.67 and 0.69.

In this way, it is advantageously possible to achieve an optimal grip of the tyre on the ground so as to improve the handling and performance of the tyre in “cold” use conditions.

Preferably, the third vulcanized elastomeric material of the radially inner portion of the tread band has a dynamic elastic modulus (E′), measured at a frequency of 10 Hz and at 23° C., comprised between 4.0 and 5.0 MPa and, more preferably, comprised between 4.2 and 4.5 MPa.

Advantageously, this preferred feature allows the third vulcanized elastomeric material of the radially inner portion of the tread band to effectively contribute to achieve an optimal ground-contacting area and an optimal grip of the tyre on the ground so as to improve the handling and performance of the tyre in “cold” use conditions.

Preferably, the third vulcanized elastomeric material of the radially inner portion of the tread band has a tandelta, measured at a frequency of 10 Hz and at 23° C., comprised between 0.49 and 0.53 and, more preferably, comprised between 0.50 and 0.52.

Advantageously, also this preferred feature allows the third vulcanized elastomeric material of the radially inner portion of the tread band to effectively contribute to achieve an optimal ground-contacting area and an optimal grip of the tyre on the ground so as to improve the handling and performance of the tyre in “cold” use conditions.

Preferably, a ratio R3 between the tandelta of the first vulcanized elastomeric material of the central sub-portion of the radially outer portion of the tread band, measured at a frequency of 10 Hz and at 70° C., and the tandelta of the third vulcanized elastomeric material of the radially inner portion of the tread band, measured at a frequency of 10 Hz and at 70° C., is comprised between 0.5 and 1.2, more preferably between 0.7 and 1.0.

In this way, it is advantageously possible to optimize and keep substantially constant over time the handling and performance of the tyre in “hot” use conditions also during travel along a straight line since the central area of the tread band of the tyre is formed in both its radially outer and radially inner portions with a vulcanized elastomeric material that is substantially “homogeneous” from a hysteresis point of view.

Preferably, a ratio R4 between the dynamic elastic modulus (E′) of the first vulcanized elastomeric material of the central sub-portion of the radially outer portion of the tread band, measured at a frequency of 10 Hz and at 70° C., and the dynamic elastic modulus (E′) of the third vulcanized elastomeric material of the radially inner portion of the tread band, measured at a frequency of 10 Hz and at 70° C., is comprised between 1.3 and 2.0, more preferably between 1.5 and 1.8.

In this way, it is advantageously possible to optimize and keep substantially constant over time the handling and performance of the tyre in fast driving conditions on dry and/or hot surfaces during travel along a straight line since the central area of the tread band of the tyre is formed, from a point of view of its “hot” deformation capability, from a vulcanized elastomeric material that adapts well to the roughness of the ground thanks to the modulus characteristics of the central sub-portion of the radially outer portion of the tread band and that at the same time achieves a high grip thanks to the modulus characteristics of the radially inner portion of the tread band.

Preferably, a ratio R5 between the dynamic elastic modulus (E′) of the second vulcanized elastomeric material of the lateral sub-portions of the radially outer portion of the tread band, measured at a frequency of 10 Hz and at 23° C., and the dynamic elastic modulus (E′) of the third vulcanized elastomeric material of the radially inner portion of the tread band, measured at a frequency of 10 Hz and at 23° C., is comprised between 1.1 and 1.6 and, more preferably, comprised between 1.2 and 1.5.

In this way, it is advantageously possible to achieve an excellent level of handling and performance of the tyre in “cold” use conditions, such as for example in the warm-up phase of the tyre or in highly demanding camber conditions in bends on a wet ground and/or in cold climatic conditions or on a non-optimal road surface.

Without wishing to be bound by any interpretative theory, the Applicant deems that in this case the third vulcanized elastomeric material of the radially inner portion of the tread band allows an adequate deformation of the lateral or shoulder sub-portions of the radially outer portion of the tread band thereby increasing their ground-contacting area.

Preferably, a ratio R6 between the tandelta of the second vulcanized elastomeric material of the lateral sub-portions of the radially outer portion of the tread band, measured at a frequency of 10 Hz and at 23° C., and the tandelta of the third vulcanized elastomeric material of the radially inner portion of the tread band, measured at a frequency of 10 Hz and at 23° C., is comprised between 1.1 and 1.6 and, more preferably, comprised between 1.2 and 1.5.

Preferably, a ratio R7 between the dynamic elastic modulus (E′) of the first vulcanized elastomeric material of the central sub-portion of the radially outer portion of the tread band, measured at a frequency of 10 Hz and at 23° C., and the dynamic elastic modulus (E′) of the third vulcanized elastomeric material of the radially inner portion of the tread band, measured at a frequency of 10 Hz and at 23° C., is comprised between 1.2 and 1.8, more preferably comprised between 1.3 and 1.7.

Preferably, a ratio R8 between the tandelta of the first vulcanized elastomeric material of the central sub-portion of the radially outer portion of the tread band, measured at a frequency of 10 Hz and at 23° C., and the tandelta of the third vulcanized elastomeric material of the radially inner portion of the tread band, measured at a frequency of 10 Hz and at 23° C., is comprised between 0.6 and 1.1, preferably between 0.7 and 1.0.

In this way, it is advantageously possible to achieve an excellent level of handling and performance of the tyre in “cold” use conditions, such as for example in the warm-up phase of the tyre or while traveling along a straight line on wet ground and/or in cold climatic conditions or on a non-optimal road surface.

Without wishing to be bound by any interpretative theory, the Applicant deems that in this case the third vulcanized elastomeric material of the radially inner portion of the tread band, having an hysteresis substantially equal to or appropriately greater than that of the first vulcanized elastomeric material of the central sub-portion of the radially outer portion of the tread band, allows to achieve an adequate thermal operation of the aforementioned central sub-portion increasing its ground-contacting area.

Preferably, a ratio R9 between the dynamic elastic modulus (E′) of the third vulcanized elastomeric material of the radially inner portion of the tread band, measured at a frequency of 10 Hz and at 23° C., and the dynamic elastic modulus (E′) of this same vulcanized elastomeric material, measured at a frequency of 10 Hz and at 70° C., is comprised between 1.2 and 2.0 and, more preferably, comprised between 1.4 and 1.9.

Advantageously, this preferred feature allows the third vulcanized elastomeric material of the radially inner portion of the tread band to have an optimal “flexibility” of its deformation characteristics in “cold” and “hot” use conditions, a flexibility that effectively contributes to achieve the following advantageous technical effects.

Firstly, the technical effect of contributing to improve and maintain over time the handling and performance of the tyre in “hot” use conditions thanks to the cooperation between the third vulcanized elastomeric material of the radially inner portion of the tread band and the second vulcanized elastomeric material of the lateral or shoulder sub-portions of the radially outer portion of the tread band, elastomeric materials having “hot” dynamic elastic moduli, i.e. a degree of deformation, very close to one another (see the values of the aforementioned ratio R1).

Secondly, the technical effect of contributing to maintain an excellent level of handling and performance of the tyre in “cold” use conditions, such as for example in the warm-up phase of the tyre or in use on wet ground and/or in cold climatic conditions or on a non-optimal road surface. This, thanks to the cooperation between the third vulcanized elastomeric material of the radially inner portion of the tread band and the first vulcanized elastomeric material of the central sub-portion of the radially outer portion of the tread band, which elastomeric materials have “cold” dynamic elastic moduli, i.e. a degree of deformation, differentiated from one another in a substantial manner (see the values of the aforementioned ratio R7).

In “cold” use conditions of the tyre, in fact, the third vulcanized elastomeric material of the radially inner portion of the tread band is much more deformable and hysteretic as compared to the first vulcanized elastomeric material of the central sub-portion of the radially outer portion of the tread band, thereby facilitating the heating of the tread band in the warm-up phase and contributing to increase, at the “cold” operating temperature, the grip of the tyre on wet surfaces and/or in cold climatic conditions or on a non-optimal road surface.

Preferably, a ratio R10 between the tandelta of the third vulcanized elastomeric material of the radially inner portion of the tread band, measured at a frequency of 10 Hz and at 23° C., and the tandelta of this same vulcanized elastomeric material, measured at a frequency of 10 Hz and at 70° C., is comprised between 1.5 and 2.4 and, more preferably, comprised between 1.7 and 2.1.

Advantageously, also this preferred feature allows the third vulcanized elastomeric material of the radially inner portion of the tread band to have an optimal “flexibility” of its hysteresis characteristics in “cold” and “hot” use conditions, a flexibility that effectively contributes to achieve the advantageous technical effects described above.

Preferably, the tyre is a tyre for rear motorcycle wheels and has a transverse curvature ratio equal to or greater than about 0.30 and preferably comprised between 0.30 and 0.35.

### BRIEF DESCRIPTION OF THE FIGURES

Additional features and advantages of the invention will become more readily apparent from the following description of some preferred embodiments thereof, given hereinbelow, for illustrative and non-limiting purposes, with reference to the attached drawings.

Such drawings are schematic and not to scale.

In the drawings:

FIG. 1 shows a perspective view of a tyre according to a preferred embodiment of the invention intended to be mounted on the rear wheel of a motorcycle; and

FIG. 2 is an enlarged schematic view of a cross section of the tyre of FIG. 1.

### DETAILED DESCRIPTION OF CURRENTLY PREFERRED EMBODIMENTS

In the figures, reference numeral 1 generally indicates a tyre for motorcycle wheels according to a preferred embodiment of the present invention. This is a tyre preferably intended to be used on a rear wheel of a motorcycle for a supersport motorcycle with large displacement, for example 600 cc.

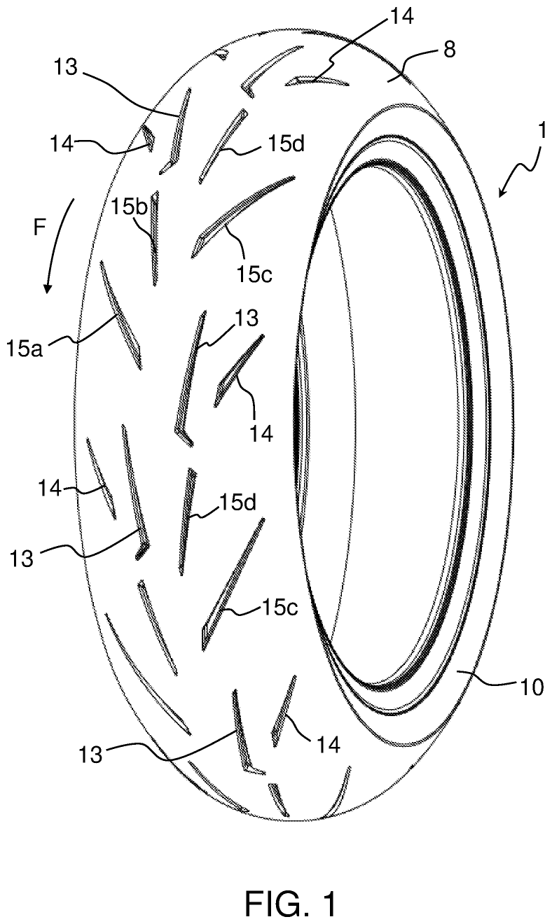

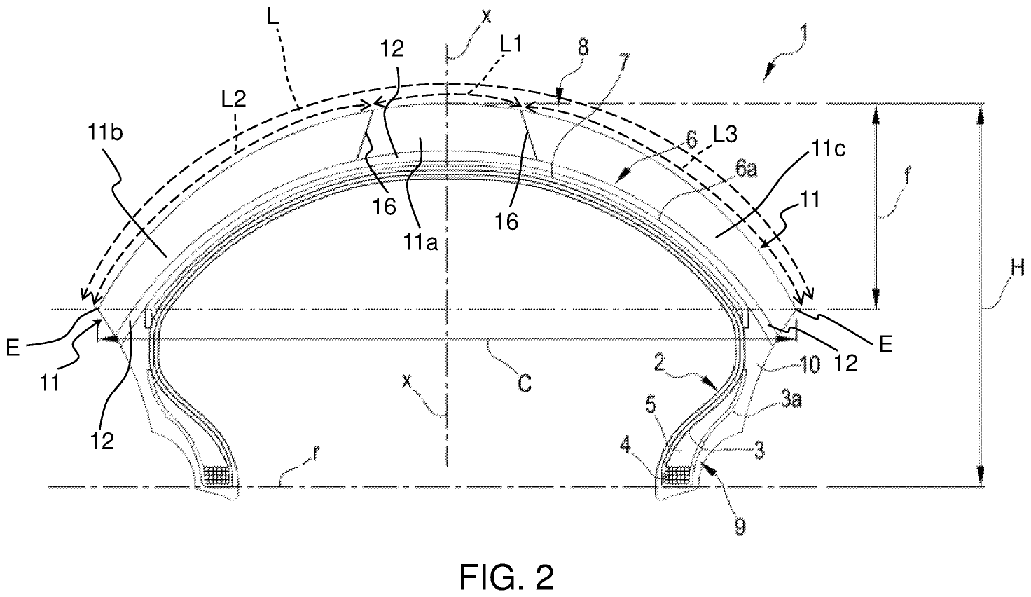

An equatorial plane X-X and a rotation axis (not shown) are defined in the tyre 1. A circumferential direction (indicated in FIG. 1 with the arrow F oriented in the direction of rotation of the tyre 1) and an axial direction, indicated in FIG. 2 with the axis r perpendicular to the equatorial plane X-X, are also defined.

The tyre 1 comprises a carcass structure 2 formed by at least one carcass layer 3 comprising a plurality of reinforcing elements (cords).

The carcass structure 2 is typically coated on the inner walls thereof by a sealing layer, or so-called “liner”, essentially consisting of an airtight layer of elastomeric material, adapted to ensure the hermetic seal of the tyre itself once inflated.

The reinforcing elements, included in the carcass layer 3, preferably comprise textile cords made of a fibrous material.

The fibrous material, used to manufacture the cords, can be made up of fibers of natural or synthetic origin selected among Rayon, Lyocell, polyesters (for example PEN, PET, PVA), aromatic polyamides (for example aramids such as Twaron®, Kevlar®), singularly or in mixture. More particularly, the fibrous material for making the cords is preferably selected among Polyester, Rayon, Lyocell, aromatic polyamides or a hybrid material formed by two or more of the aforementioned materials.

The reinforcing elements included in the at least one carcass layer 3 are preferably arranged in the radial direction, i.e. according to an angle comprised between 70° and 110°, more preferably between 80° and 100°, with respect to the circumferential direction.

The at least one carcass layer 3 is shaped according to a substantially toroidal configuration and is engaged, by means of its opposite circumferential edges 3a, to at least one annular reinforcing structure.

In particular, the opposite lateral edges 3a of the at least one carcass layer 3 can be turned about the annular reinforcing structures each comprising one or more metallic annular bead cores 4 and a tapered elastomeric filler 5 that occupies the space defined between the carcass layer 3 and the corresponding turned lateral edge 3a of the carcass layer 3.

The area of the tyre comprising the bead core 4 and the filling 5 forms the so-called bead 9 intended to anchor the tyre 1 on a corresponding mounting rim, not illustrated.

In an embodiment that is not illustrated, the at least one carcass layer 3 is made by bringing together a plurality of strips of elastomeric material reinforced by the aforementioned cords and has its opposite lateral edges associated without turning to particular annular reinforcing structures provided with two annular inserts. A filler made of elastomeric material can be arranged at an axially outer position with respect to the first annular insert. A second annular insert can, on the other hand, be arranged at an axially outer position with respect to the end of the carcass layer. Finally, at an axially outer position with respect to said second annular insert, and not necessarily in contact therewith, a further filler may possibly be provided which ends the construction of the annular reinforcing structure.

A belt structure 6 comprising at least one belt layer 6a typically formed by rubber-coated cords is circumferentially applied, at a radially outer position, on the carcass structure 2.

Preferably, the layer 6a is made by cords arranged substantially parallel and side-by-side to each other to form a plurality of coils. Such coils are substantially oriented according to the circumferential direction (typically with an angle between 0° and) 5°, such a direction usually being called “zero degrees” with reference to its laying direction with respect to the circumferential direction of the tyre.

Preferably, the “zero degrees” layer 6a can comprise axially adjacent windings of a single cord, or of a band of rubber-coated fabric comprising axially adjacent cords.

The cords of the layer 6a are textile or metallic cords. Preferably, such cords are metallic cords, made of steel wires having a high carbon content, in other words steel wires with a carbon content of at least 0.6-0.7%.

Preferably, such metallic cords have high elongation (HE).

In order to improve the adhesion between the belt structure 6 and the carcass structure 2 an adhesion layer 7 made of elastomeric material may be provided interposed between the two aforementioned structures.

In an embodiment that is not illustrated, the belt structure 6 can consist of at least two radially overlapping layers. The layers are arranged so that the cords of the first belt layer are oriented obliquely with respect to the circumferential direction of the tyre, whereas the cords of the second layer also have an oblique orientation, but substantially symmetrically crossed with respect to the cords of the first layer.

A tread band 8 is circumferentially overlapped on the belt structure 6, on which, after a molding operation carried out simultaneously with the vulcanization of the tyre, longitudinal and/or transversal grooves are typically formed, arranged to define a desired tread pattern.

FIG. 1 shows, as a non-limiting example, a tread pattern comprising a plurality of grooves variously arranged on opposite sides of the equatorial plane X-X of the tyre 1.

Preferably, the tread pattern comprises a first circumferential succession of substantially L-shaped grooves 13, a second circumferential succession of grooves 14 at an axially outer position with respect to the grooves 13 and a third circumferential succession of groups of grooves 15a, 15b, 15c and 15d, variously inclined with respect to the equatorial plane X-X of the tyre 1 and circumferentially interposed between the grooves 13.

For the sake of simplicity, such grooves are not represented in FIG. 2.

The tyre 1 can comprise a pair of sidewalls 10 laterally applied to said carcass structure 2 on opposite sides thereof.

The tyre 1 has a cross-section height H measured, on the equatorial plane X-X, between the top of the tread band 8 and the fitting diameter, identified by the reference line r, passing through the beads of the tyre 1.

The tyre 1 also has a maximum width C of its transversal cross-section defined by the distance between the axially opposite ends E of the profile of the tread band 8, and a curvature ratio defined as the ratio between the distance f of the top of the tread band 8 from the lines passing through the ends E of the tread band 8 itself, measured on the equatorial plane of the tyre 1 and the aforementioned maximum width C. The axially opposite ends E of the tread band 8 can be formed at an edge.

In particular, the tyre 1 has a transversal cross-section distinguished by a high curvature ratio, preferably a curvature ratio f/C of at least about 0.30.

In a preferred embodiment, the motorcycle tyre 1 of the invention is intended to be mounted on the rear wheel having dimensions of the chord substantially comprised between 160 and 210 mm.

Preferably, the distance f between the radially outermost point of the tread band 8 and the line passing through the axially opposite ends E of the tread band 8 itself of the tyre 1 is comprised substantially between 50 and 70 mm.

Preferably, for a tyre 1 intended to be mounted on the rear wheel of a motorcycle the transversal curvature ratio f/C is substantially equal to or greater than about 0.30, even more preferably comprised between 0.30 and 0.35.

Preferably, the total height/chord ratio H/C is substantially comprised between 0.5 and 0.65.

In preferred embodiments, the tyres 1 allow to achieve a better performance when they have sidewalls 10 of substantial height, for example, with values of the sidewall height ratio (H−f)/H equal to or greater than 0.35, more preferably equal to or greater than 0.4 when the tyre 1 is intended to be mounted on the rear wheel of a motorcycle.

Preferably, the tyre 1 has a ratio between shoulder radius and maximum cross section width equal to or greater than 0.60.

According to the invention, the tread band 8 is of the so-called “cap-and-base” type and is made with at least three different elastomeric materials.

In the preferred embodiment illustrated in the figures, the tread band 8 comprises a radially outer portion 11 comprising:
a1) a central sub-portion 11a arranged astride of the equatorial plane X-X of the tyre 1 and made with a first vulcanized elastomeric material, and
a2) a pair of lateral sub-portions 11b, 11c, distal with respect to the equatorial plane X-X of the tyre 1 and arranged on opposite sides of the central sub-portion 11a.

As outlined above, the lateral sub-portions 11b, 11c of the tread band 8 are made with a second vulcanized elastomeric material.

In the preferred embodiment illustrated in the figures, the tread band 8 comprises a radially inner portion 12 extending below the radially outer portion 11 of the tread band 8 and along the entire axial development thereof.

As outlined above, the radially inner portion 12 of the tread band 8 is made with a third vulcanized elastomeric material.

Preferably, the central annular sub-portion 11a of the tread band 8 has an axial development L1 that transversely extends for 25-40%, more preferably for 30-35%, of the total axial development L of the tread band 8.

Preferably, the lateral sub-portions 11b, 11c of the tread band 8 have a respective axial development L2, L3 that transversely extends for 25-40%, more preferably for 30-35%, of the total axial development L of the tread band 8.

The central sub-portion 11a of the radially outer portion 11 of the tread band 8 is advantageously formed in one piece, for example depositing contiguous circumferential spirals of at least one continuous elongated element of the aforementioned first vulcanized elastomeric material.

Conversely, the lateral sub-portions 11b, 11c of the tread band 8 are advantageously formed in one piece, for example depositing contiguous circumferential coils of at least one continuous elongated element of the aforementioned second vulcanized elastomeric material.

In this way and as outlined above, a pair of interfaces 16 between the first and the second vulcanized elastomeric material are defined in the radially outer portion 11 of the tread band 8 and at opposite sides of the equatorial plane X-X of the tyre 1 and of the central annular portion 11a.

In this preferred configuration of the tread band 8, the interfaces 16 therefore separate the central sub-portion 11a from the lateral sub-portions 11b, 11c of the radially outer portion 11 of the tread band 8 along the axial direction.

Preferably, the lateral sub-portions 11b, 11c of the radially outer portion 11 of the tread band 8 and, therefore, the interfaces 16, are arranged at a distance from the equatorial plane X-X of the tyre 1, as defined above, comprised between 25-40% more preferably, between 30-35% of the axial half-development L/2 of the tread band.

In the preferred embodiment shown in FIG. 2, the interfaces 16 can converge towards the equatorial plane X-X of the tyre 1 from the inside to the outside of the tread band 8, the interfaces being oriented according to a direction inclined with respect to the equatorial plane X-X by an angle comprised between 30° and 50°, preferably between 35° and 40°.

In this preferred configuration of the tread band 8, the radially inner portion 12 of the tread band 8 extends substantially for the entire axial development of the belt structure 6.

In this preferred configuration of the tread band 8, therefore, the radially inner portion 12 of the tread band 8 is interposed along the radial direction between the belt structure 6, the central sub-portion 11a and the lateral sub-portions 11b, 11c of the radially outer portion 11 of the tread band 8.

The rubber compounds for the different portions of the tread band 8 as well as for the other semi-worked products forming the tyre 1 comprise at least one elastomeric diene polymer (a1).

Advantageously, such rubber compounds comprise at least one alpha-olefin and have specific formulations as will be better detailed hereinafter.

According to an embodiment, said at least one elastomeric diene polymer (a1) can be selected for example from elastomeric diene polymers commonly used in elastomeric compositions capable to be cross-linked with sulfur (vulcanization), which are particularly suitable for the production of tyres, i.e. from elastomeric polymers or copolymers with an unsaturated chain having a glass transition temperature (Tg) normally below 20° C., preferably in the range from 0° C. to −110° C. These polymers or copolymers may be of natural origin or may be obtained by solution polymerization, emulsion polymerization or gas-phase polymerization of one or more conjugated diolefins, optionally mixed with at least one comonomer selected from monovinylarenes and/or polar comonomers.

Preferably, for the tread rubber compound polybutadiene (BR) and/or styrene-butadiene polymers (SBR), for example SSBR (solution-polymerized styrene butadiene elastomer) or E-SBR (emulsion-polymerized styrene butadiene elastomer) alone or in mixture, may be used.

Preferably, the styrene-butadiene polymer (SBR) can be present in the rubber compounds of the present invention in variable amounts from about 50 to 100 phr, more preferably from 70 to 100 phr.

Advantageously, polybutadiene (BR) can be absent or be included in the rubber compounds of the present invention and in particular in the tread rubber compound in amounts from about 0 phr to 40 phr, more preferably from about 10 to 30 phr.

Preferably, the styrene-butadiene polymer can be obtained from solution or from emulsion, and generally comprises styrene in amounts from about 10 to 40% by weight, preferably from about 15 to 30% by weight.

Preferably, the styrene-butadiene polymer can have low molecular weight, having an average molecular weight Mn of lower than 200,000 g/mol, preferably comprised between 150,000 and 200,000 g/mol.

The elastomeric material of the different portions of the tread band 8 comprises at least one reinforcing filler present in an amount generally comprised between 1 phr and 130 phr.

Such a reinforcing filler is preferably selected from carbon black and the so-called white fillers: silica, alumina, silicates, hydrotalcite, calcium carbonate, kaolin, titanium dioxide and mixtures thereof.

The reinforcing filler used in the elastomeric material of the different portions of the tread band 8 can comprise only carbon black or both carbon black and one or more white fillers, for example silica.

In a preferred embodiment, the first vulcanized elastomeric material of the central sub-portion 11a of the radially outer portion 11 of the tread band 8 comprises an amount greater than 75%, preferably equal to or greater than 80%, more preferably equal to or greater than 85%, more preferably equal to or greater than 90%, more preferably equal to or greater than 95% by weight over the total weight of the reinforcing fillers, of a “white” reinforcing filler as defined above.

More preferably, such a “white” reinforcing filler is selected from silica, alumina, silicates, hydrotalcite, calcium carbonate, kaolin, titanium dioxide, and mixtures thereof.

Even more preferably, the “white” reinforcing filler can be a pyrogenic silica or a precipitated silica, with a BET surface area (measured according to the ISO Standard 5794/1) comprised between 50 m²/g and 500 m²/g, preferably between 70 m²/g and 200 m²/g.

In this way, it is advantageously possible to achieve a rapid warm-up of the tread band 11 of the tyre 1, as well as an excellent grip in different conditions of the road surface.

In a preferred embodiment, the second elastomeric material of the lateral sub-portions 11b, 11c of the radially outer portion 11 of the tread band 8 comprises an amount greater than 75%, preferably equal to or greater than 80%, more preferably equal to or greater than 85%, more preferably equal to or greater than 90%, more preferably equal to or greater than 95% by weight over the total weight of the reinforcing fillers, of carbon black.

Preferably, the carbon black is selected among those having a surface area not smaller than 20 m²/g, preferably greater than 50 m²/g (determined by STSA—statistical thickness surface area according to ISO 18852:2005).

The carbon black can for example be N234, N326, N330, N375, N550 or N660 marketed by Birla Group (India) or CRX 1391 of Cabot Corporation.

The reinforcing filler can comprise mixtures, for example of carbon black and silica.

In this way, it is advantageously possible to achieve an optimal support when cornering and optimal traction in acceleration to manage the torque generated by high-performance motorcycles, such as for example the last-generation superbikes.

The elastomeric compositions described above and those of the other components of the tyre 1 can be vulcanized according to known techniques, in particular with sulfur-based vulcanization systems, commonly used for elastomeric polymers. To this end, in the elastomeric composition, after one or more thermomechanical treatment steps, a sulfur-based vulcanizing agent is incorporated together with vulcanization accelerants. In the final step of the treatment, the temperature is kept generally below 140° C., so as to avoid any undesired pre-cross-linking phenomena.

The most advantageously used vulcanizing agent is sulfur or sulfur-containing molecules (sulfur donors), with accelerants and activators known to those skilled in the art.

Activators that are particularly effective are zinc-based compounds and in particular ZnO, ZnCO₃, zinc salts of saturated or unsaturated fatty acids containing 8 to 18 carbon atoms, such as, for example, zinc stearate, which are preferably formed in situ in the elastomeric composition from ZnO and fatty acid, and also BiO, PbO, Pb₃O₄, PbO₂, or mixtures thereof.

Accelerants that are commonly used may be selected from: dithiocarbamates, guanidine, thiourea, thiazoles, sulfonamides, thiourams, amines, xanthates, or mixtures thereof.

The elastomeric compositions used can comprise other additives commonly selected based on the specific application for which each composition is intended.

For example, the following additives can be added to said elastomeric compositions: antioxidants, anti-ageing agents, plasticizers, adhesives, anti-ozonants, modifying resins, fibers (aramids or of natural origin), or mixtures thereof.

In the following Table 1 an example is given purely for indicative purposes of the rubber compounds that after vulcanization make the first, the second and the third vulcanized elastomeric material in a preferred embodiment of the tyre 1.

The amounts of the various components of an elastomeric composition are generally provided in phr as defined above.

TABLE 1

| | First | Second | |
|---|---|---|---|
| | elastomeric | elastomeric | Third |
| | material | material | elastomeric |
| | (central sub- | (lateral sub- | material |
| | portion of | portions of | (radially |
| | the radially | the radially | inner |
| | outer portion | outer portion | portion |
| | of the | of the | of the |
| Component | tread band) | tread band) | tread band) |
| S-SBR | 70-85* | 100* | 60-80* |
| E-SBR | — | — | 20-40* |
| BR | 15-30 | — | — |
| CB | 10-30 | 60-80 | 70-90 |
| Silica | 80-100 | — | — |
| Liquid copolymer | — | 10-20 | — |
| Extension oil of the | 26-32 | 37.5-40 | 40-42 |
| SBR polymers and | | | |
| free oil | | | |
| Lubricant | 10-20 | 15-25 | 5-15 |
| Resin 1 | 15-25 | 10-20 | — |
| Resin 2 | 5-10 | 10-20 | 10-20 |
| Resin 3 | — | — | 10-15 |
| Zinc salt | 3-5 | — | — |
| Stearic acid | — | 1-2 | 1-2 |
| Zinc oxide | — | 2.5 | 5 |
| Silane | 6-8 | 1-2 | 1 |
| Zinc stearate | 2-3 | 1-2 | — |
| Wax | 1-1.5 | 1-1.5 | 1-1.5 |
| Antioxidant | 1-2 | 1-2 | 1-2 |
| Anti-ozonant | 2-3 | 2-3 | 2-3 |
| Sulfur | 1-2 | 1-2 | 1-2 |
| Cross-linker | — | 3-4 | — |
| Adhesion promoter | — | — | 1-2 |
| Vulcanization | 2-3 | — | 1-2 |
| accelerant 1 | | | |
| Vulcanization | 1-2 | 2-3 | 1-2 |
| accelerant 2 | | | |
| Vulcanization | 0.3-1 | 0.5-1 | — |
| accelerant 3 | | | |
| Vulcanization | — | 0.3 | 0.3 |
| retardant | | | |

*phr of dry polymer without extension oil
S-SBR: solution-polymerized styrene-butadiene copolymer (phr given as dry polymer, extended with 37.5 phr of oil TDAE per 100 phr of dry elastomeric polymer)-TUFDENE E680 (Asahi Kasei)
E-SBR: emulsion-polymerized styrene-butadiene copolymer (phr given as dry polymer, extended with 37.5 phr of RAE oil per 100 phr of dry elastomeric polymer)-INTOL 1789 (Versalis)
BR: functionalized low-cis polybutadiene-YB03 (Asahi Kasei)
CB: CRX ™ 1391 (Cabot)
Silica: ULTRASIL ® 7000 (Evonik)
Liquid copolymer (grip enhancer): low molecular weight butadiene/styrene liquid copolymer (4500 g/mol)-RICON ® 100 (Cray Valley)
Extension oil: TDAE (Orgkhim)
Lubricant: tri(2-ethylhexyl)phosphate (TOF) (Lanxess)
Resin 1: hydrocarbon resin-KRISTALEX ® 5140LV (Eastman)
Resin 2: hydrocarbon resin-RHENOSIN ® TT 90 (Lanxess)
Resin 3: hydrocarbon resin-NOVARES ® TT 30 (Reutgers Germany GmbH)
Zinc salt: Zinc neodecanoate 50 (Rhein Chemie)
Stearic acid: Stearic acid (Undesa)
Zinc oxide: RHENOGRAN ® ZnO (Zincol Ossidi)
Silane: SILAN (Evonik)
Zinc stearate: ACID GRAS SARE DE ZINC (Eigenmann & Veronelli)
Wax: WAX (Repsol)
Antioxidant: 2,2,4-Trimethyl-1,1-dihydroquinolin-TMQ (Lanxess)
Anti-ozonant: N-(1,3-dimethylbutyl)-N′-phenyl-p-phenylenediamine-SANTOFLEX ® 6PPD (Eastman)
Sulfur: RHENOCURE ® IS 90 P (Rhein Chemie)
Cross-linker: bi-functional 1,6-bis(NN′-dibenzylthiocarbamoyldithio)-hexane-VULCUREN ® KA 9188 (Lanxess)
Adhesion promoter: Hexamethylene-1,6-bis(thiosulfate) disodium di-hydrate salt-DURALINK ® HTS (Eastman)
Vulcanization accelerant 1: N-tert-butyl-benzothiazole sulfenamide-TBBS (Huatai Chemicals)
Vulcanization accelerant 2: dibenzothiazole disulfide-RHENOGRAN ® MBTS 80 (Rhein Chemie)
Vulcanization accelerant 3: Tetrabenzyl thiuram disulfide-TBZTD (Akrochem)
Vulcanization retardant: N-(Cyclohexylthio)phthalimide-PVI (Akrochem)

According to the invention, the first vulcanized elastomeric material of the central sub-portion 11a of the radially outer portion 11 of the tread band 8 has a dynamic elastic modulus E′ measured at a frequency of 10 Hz and at 23° C. greater than the dynamic elastic modulus E′ measured at a frequency of 10 Hz and at 23° C. of the second vulcanized elastomeric material of the lateral sub-portions 11b, 11c.

Moreover, the first vulcanized elastomeric material of the central sub-portion 11a of the radially outer portion 11 of the tread band 8 and the second vulcanized elastomeric material of the lateral sub-portions 11b, 11c have a respective dynamic elastic modulus E′ measured at a frequency of 10 Hz and at 23° C. comprised between 5.2 and 6.5 MPa and, preferably between 5.8 and 6.4 MPa.

Still according to the invention, the third vulcanized elastomeric material of the radially inner portion 12 of the tread band 8 has a dynamic elastic modulus E′ measured at a frequency of 10 Hz and at 23° C. lower than the dynamic elastic modulus E′, measured at a frequency of 10 Hz and at 23° C., of the aforementioned first vulcanized elastomeric material of the central sub-portion 11a and second vulcanized elastomeric material of the lateral sub-portions 11b, 11c of the radially outer portion 11 of the tread band 8.

As outlined above, the Applicant deems that in “cold” use conditions of the tyre 1 the third vulcanized elastomeric material present in the radially inner portion 12 of the tread band 8 is subject—at the lateral or shoulder portions of the tyre—to deformations (correlated to the elastic modulus E′) and hysteresis phenomena (correlated to the tandelta parameter) that allow to “heat” the overlying radially outer portion 11 of the tread band 8 (stiffer and with less hysteresis), allowing this latter portion to better adhere to the ground in wet and/or cold conditions.

According to the invention, the ratio R1 between the dynamic elastic modulus E′ of the second vulcanized elastomeric material of the lateral sub-portions 11b, 11c of the radially outer portion 11 of the tread band 8, measured at a frequency of 10 Hz and at 100° C., and the dynamic elastic modulus E′ of the third vulcanized elastomeric material of the radially inner portion 12 of the tread band 8, measured at a frequency of 10 Hz and at 70° C., is comprised between 0.8 and 1.2, preferably between 0.9 and 1.1.

Moreover, the ratio R2 between the tandelta of the second vulcanized elastomeric material of the lateral sub-portions 11b, 11c of the radially outer portion 11 of the tread band 8, measured at a frequency of 10 Hz and at 100° C., and the tandelta of the third vulcanized elastomeric material of the radially inner portion 12 of the tread band 8, measured at a frequency of 10 Hz and at 70° C., is comprised between 0.8 and 1.2, preferably between 0.9 and 1.1.

As outlined above, the Applicant has experimentally observed that by controlling at values close to one the aforementioned ratios R1 between the deformability characteristics—correlated to the values of dynamic elastic modulus E′—as well as R2 between the hysteresis characteristics—correlated to the tandelta values—it is advantageously possible to have, in “hot” use conditions of the tyre, an optimal dynamic and hysteresis behavior both in the shoulder areas, limiting phenomena of premature wear and performance degradation, and in the central area, ensuring optimal driving performance along a straight course.

The tyre 1 can also be provided with one or more of the preferred features described above achieving the corresponding advantageous technical effects.

The invention will now be illustrated by means of some examples to be considered for illustrating and not limiting purposes thereof.

### Properties of Vulcanized Elastomeric Compositions

In the following Table 2 an example is given purely for illustration purposes of rubber compounds which after vulcanization make the first, the second and the third vulcanized elastomeric material in a particularly preferred embodiment of the tyre 1.

The amounts of the various components of an elastomeric composition are generally provided in phr as defined above.

TABLE 2

| | First | Second | |
|---|---|---|---|
| | elastomeric | elastomeric | Third |
| | material | material | elastomeric |
| | (central sub- | (lateral sub- | material |
| | portion of | portions of | (radially |
| | the radially | the radially | inner |
| | outer portion | outer portion | portion |
| | of the | of the | of the |
| Component | tread band) | tread band) | tread band) |
| S-SBR | 80* | 100* | 70* |
| E-SBR | — | — | 30* |
| BR | 20 | — | — |
| CB | 15 | 75 | 80 |
| Silica | 85 | — | — |
| Liquid copolymer | — | 20 | — |
| Extension oil of | 30 | 37.5 | 37.5 |
| SBR polymers | | | |
| Lubricant | 15 | 20 | 10 |
| Resin 1 | 20 | 15 | — |
| Resin 2 | — | — | 7 |
| Resin 3 | — | — | 15 |
| Zinc salt | 4 | — | — |
| Stearic acid | — | 1.5 | 0.5 |
| Zinc oxide | — | 2.5 | 5 |
| Silane | 7 | 1.5 | 1 |
| Zinc stearate | 2.5 | 2 | — |
| Wax | 1 | — | 1 |
| Antioxidant | 1 | 2 | 2 |
| Anti-ozonant | 3 | 2.5 | 2.5 |
| Sulfur | 1.3 | 1.5 | 2 |
| Cross-linker | — | 3.5 | — |
| Adhesion promoter | — | — | 1.5 |
| Vulcanization | 2.5 | — | — |
| accelerant 1 | | | |
| Vulcanization | 1.5 | 2.5 | 0.5 |
| accelerant 2 | | | |
| Vulcanization | — | 1.0 | 2.5 |
| accelerant 3 | | | |
| Vulcanization | — | 0.3 | 0.3 |
| retardant | | | |

*phr of dry polymer without extension oil
S-SBR: solution-polymerized styrene-butadiene copolymer (phr given as dry polymer, extended with 37.5 phr of oil TDAE per 100 phr of dry elastomeric polymer)-TUFDENE E680 (Asahi Kasei)
E-SBR: emulsion-polymerized styrene-butadiene copolymer (phr given as dry polymer, extended with 37.5 phr of RAE oil per 100 phr of dry elastomeric polymer)-INTOL 1789 (Versalis)
BR: functionalized low-cis polybutadiene-YB03 (Asahi Kasei)
CB: CRXTM 1391 (Cabot)
Silica: ULTRASIL ® 7000 (Evonik)
Liquid copolymer: low molecular weight butadiene/styrene liquid copolymer (4500 g/mol)-RICON ® 100 (Cray Valley)
Extension oil: TDAE (Orgkhim)
Lubricant: tri(2-ethylhexyl)phosphate (TOF) (Lanxess)
Resin 1: hydrocarbon resin-KRISTALEX ® 5140LV (Eastman)
Resin 2: tert butyl phenol resin (BASF)
Resin 3: hydrocarbon resin-RHENOSIN ® TT 90 (Lanxess)
Zinc salt: Zinc neodecanoate 50 (Rhein Chemie)
Stearic acid: Stearic acid (Undesa)
Zinc oxide: RHENOGRAN ® ZnO (Zincol Ossidi)
Silane: SILAN (Evonik)
Zinc stearate: ACID GRAS SARE DE ZINC (Eigenmann & Veronelli)
Wax: WAX (Repsol)
Antioxidant: 2,2,4-Trimethyl-1,1-dihydroquinolin-TMQ (Lanxess)
Anti-ozonant: N-(1,3-dimethylbutyl)-N′-phenyl-p-phenylenediamine-SANTOFLEX ® 6PPD (Eastman)
Sulfur: RHENOCURE ® IS 90 P (Rhein Chemie)
Cross-linker: bi-functional 1,6-bis(NN′-dibenzylthiocarbamoyldithio)-hexane-VULCUREN ® KA 9188 (Lanxess)
Adhesion promoter: Hexamethylene-1,6-bis(thiosulfate) disodium di-hydrate salt-DURALINK ® HTS (Eastman)
Vulcanization accelerant 1: N-tert-butyl-benzothiazole sulfenamide-TBBS (Huatai Chemicals)
Vulcanization accelerant 2: dibenzothiazole disulfide-RHENOGRAN ® MBTS 80 (Rhein Chemie)
Vulcanization accelerant 3: N-tert-butyl-benzothiazole sulfenamide-TBBS 80 (Rhein Chemie)
Vulcanization retardant: N-(Cyclohexylthio)phthalimide-PVI (Akrochem)

The following Table 3 shows the results of the static and dynamic mechanical analyses carried out on samples of the compositions used for the three materials of the radially inner and outer portions 12, 11 of the tread band 8 of a tyre 1 according to the invention, the formulation of which has been indicated in the previous Table 1.

These analyses were carried out at the temperature and frequency condition and according to the techniques indicated above.

TABLE 3

| | | |
|---|---|---|
| First elastomeric | Second elastomeric | |
| material | material | Third |
| (central | (lateral sub- | elastomeric |
| sub-portion | portions of the | material |
| of the | radially | (radially |
| radially | outer portion | inner portion |
| outer portion | of the | of the |
| of the tread band) | tread band) | tread band) |

Static characteristics

| | | | |
|---|---|---|---|
| CA1 (MPa) | 1.5 | 1.2 | 1.1 |
| CA3 (MPa) | 7.8 | 6.1 | 5 |

“Cold” dynamic characteristics

| | | | |
|---|---|---|---|
| E′ 23°C-10 Hz | 6.368 | 5.830 | 4.445 |
| (MPa) | | | |
| Tandelta 23°C- | 0.427 | 0.680 | 0.514 |
| 10 Hz | | | |

“Hot” dynamic characteristics

| | | | |
|---|---|---|---|
| E′ 70° C.-10 Hz | 5.305 | — | — |
| (MPa) | | | |
| Tandelta 70° C.- | 0.283 | — | — |
| 10 Hz | | | |
| E′ 100° C.-10 Hz | — | 2.760 | — |
| (MPa) | | | |
| Tandelta 100° C.- | — | 0.268 | — |
| 10 Hz | | | |
| E′ 70° C.-10 Hz | — | — | 2.706 |
| (MPa) | | | |
| Tandelta 70° C.- | — | — | 0.269 |
| 10 Hz | | | |

The following Table 4 shows the ratios between the dynamic mechanical characteristics of elastic modulus E′ and of tandelta indicated above between the various vulcanized elastomeric materials and in each vulcanized elastomeric material as far as it is of interest for the purposes of the present invention.

TABLE 4

| “Hot” ratios between different materials | |
|---|---|
| (the parameter of interest in parentheses) | |
| R1 (E′ moduli) | 1 |
| R2 (tandelta) | 1 |
| R3 (tandelta) | 0.85 |
| R4 (E′ moduli) | 1.6 |
| “Cold” ratios between different materials | |
| (the parameter of interest in parentheses) | |
| R5 (E′ moduli) | 1.3 |
| R6 (tandelta) | 1.3 |
| R7 (E′ moduli) | 1.4 |
| R8 (tandelta) | 0.8 |

From Table 4 it can clearly be seen that the values of the ratios R1, R2, R5 and R6, equal or close to 1, are predictive of a homogeneous behavior both in “hot” and “cold” conditions between the second and the third vulcanized elastomeric material, i.e. between the rubber compound present in the radially outer portion of the shoulder area and the rubber compound present in the radially inner portion of the tyre 1.

From Table 4 it can also be clearly seen that the “hot” values of the ratios R3 and R4 of tandelta and dynamic elastic modulus E′ between the first and the third vulcanized elastomeric material present in the central sub-portion of the radially outer portion and in the radially inner portion of the tread band of the tyre 1 are predictive of an adequately differentiated behavior between such materials, i.e. a more deformable and hysteretic behavior in the base portion of the tread band and a more rigid and less hysteretic behavior in the central sub-portion of the radially outer portion of the tread band.

In this way and as outlined above, such vulcanized elastomeric materials allow to achieve optimal “hot” handling and road holding performance of the tyre during travel along a straight course.

Finally, from Table 4 it can clearly be seen that the “cold” values of the ratios R7 and R8 of dynamic elastic modulus E′ and tandelta between the first and the third vulcanized elastomeric material present in the radially outer central sub-portion and in the radially inner portion of the tyre 1 are predictive of an adequately differentiated behavior between such materials, i.e. a more deformable and hysteretic behavior in the base portion of the tread band and a more rigid and less hysteretic behavior in the radially outer central portion of the tread band.

In this way and as outlined above, such vulcanized elastomeric materials allow to achieve optimal “cold” handling and road holding performance of the tyre during travel along a straight course.

### Outdoor Tests on Tyres

The Applicant, looking for improved performance, took as base of a comparative driving test the tyre for a rear wheel Pirelli Diablo Rosso™ IV 190/55ZR17 which proved and still is a benchmark tyre that is highly valued by sports users.

The choice to carry out the tests on rear tyres was considered particularly demanding since in sports driving the rear tyre is more thermally stressed with respect to the front one.

Both the tyre according to the invention, and the comparative tyre had a “cap-and-base” configuration of the tread band with the difference that the comparative tyre had a configuration with two different vulcanized elastomeric materials, that is, a first elastomeric material in lateral sub-portions of the radially outer portion of the tread band and a second elastomeric material in a central sub-portion of the radially outer portion and in a radially inner portion of the tread band.

The tyre according to the invention had a configuration with three different vulcanized elastomeric materials, two radially outer and one radially inner, as illustrated above with reference to FIG. 2.

The rubber compounds given in Table 2 with the mechanical characteristics given in Tables 3 and 4 were used to make the radially inner and radially outer portions of the tread band of a supersport tyre for a rear wheel of analogous size with respect to the comparative tyre.

The tread band of the comparative tyre of the cap-and-base type was made with the two materials given in the following Table 5 (ingredients as previously indicated in Table 2 wherever applicable).

TABLE 5
(Comparative tyre)

| | First elastomeric | Second elastomeric |
|---|---|---|
| | material of | material of the central |
| | the lateral sub-portions | sub-portion of the |
| | of the radially | radially outer portion |
| | outer portion of the | and of the radially inner |
| Component | tread band | portion of the tread band |
| S-SBR | 80* | 70* |
| BR | 20 | 30 |
| CB | 15 | 10 |
| Silica | 85 | 90 |
| Extension oil | 30 | 26.2 |
| Lubricant | 15 | 15 |
| Resin 1 | 20 | — |
| Resin 2 | — | 20 |
| Resin 3 | 7 | — |
| Zinc salt | 4 | — |
| Stearic acid | — | 2.5 |
| Zinc oxide | — | 2 |
| Silane | 7 | 7 |
| Zinc stearate | 2.5 | 2.5 |
| Wax | 1 | 1 |
| Antioxidant | 1 | 1 |
| Anti-ozonant | 3 | 3 |
| Sulfur | 1.3 | 1.5 |
| Vulcanization | 3.5 | 3.5 |
| accelerant 1 | | |
| Vulcanization | 1 | 1 |
| accelerant 2 | | |
| Vulcanization | — | |
| accelerant 3 | | |
| Vulcanization | — | 0.3 |
| retardant | | |

*phr of dry polymer without extension oil

Different test sessions were carried out in a private race track by performing a series of maneuvers to test grip and maneuverability both on dry and on wet ground. The evaluation of the driver is an average of the evaluations attributed in the various maneuvers.

In the test on dry ground the conditions were as follows. Tyre inflation pressure: 2.5 bar; asphalt temperature of the track: 39° C.; air temperature: 18° C.

In the test on wet ground the conditions were as follows. Tyre inflation pressure: 2.9 bar; asphalt temperature of the track: 8° C.; air temperature: 8° C.

The test was carried out with a “Super sport” motorcycle model BMW S1000 R.

The following Tables 6 and 7 summarize the scores given by the test pilot in the tests on dry and wet ground, respectively, for the various types of performance required of the tested tyre.

In the tests on dry ground, moreover, different sets of tyres according to the invention and comparative tyres were tested both over a single lap (columns 1 and 2 of Table 6), and completing 20 laps of the track (columns 3 and 4 of Table 6) to verify, in this second case, the performance degradation due to high-intensity use (“hard handling”) simulating a race on a track or a couple of training sessions (about 100 km traveled).

Table 5 indicates, for the tyre according to the invention, an evaluation of equal performance with respect to the comparative tyre by means of the symbol “=” and an evaluation of improvement with respect to the comparative tyre by means of the symbol “+” in greater number as the improvement in performance increases.

It should be noted that there is homogeneity of evaluation only among columns 1 and 2 (single lap) and columns 3 and 4 (after 20 laps of track). In other words, the evaluations over a single lap were carried out with a set of tyres that is not the same set of tyres as the race simulation tests and such a single lap is not the first lap of the race simulation.

TABLE 6
(test on dry ground)

| | | | | |
|---|---|---|---|---|
| | | Tyre | Com- | Tyre |
| | Com- | according | parative | according to |
| | parative | to the | tyre (after | the invention |
| | tyre | invention | 20 laps | (after |
| | (single | (single | of the | 20 laps of the |
| Tyres | lap) | lap) | track) | track) |

Type of performance
Stability of travel along a straight course

| | | | | |
|---|---|---|---|---|
| Acceleration stability | = | = | = | = |
| Stationary stability | = | = | = | = |

Stability of travel along a bend

| | | | | |
|---|---|---|---|---|
| Set-up general | = | = | = | = |
| stability | | | | |
| Acceleration stability | = | = | = | = |
| Responsiveness | = | + | = | = |

Driving fundamentals

| | | | | |
|---|---|---|---|---|
| Driving homogeneity | = | + | = | + |
| Thrust maintenance | = | + | = | ++ |
| Driving | = | + | = | + |
| precision/Contact | | | | |
| feeling | | | | |

TABLE 7
(test on wet ground-single lap)

| | | |
|---|---|---|
| | Comparative | Tyre according to the |
| Tyres | tyre | invention |

Type of performance
Grip

| | | |
|---|---|---|
| Braking thrust | = | = |
| Grip | = | = |
| Contact feeling | = | = |
| Safety feeling | = | = |

Handling

| | | |
|---|---|---|
| Lightness | = | = |
| Ease of driving | = | = |
| Maintenance of driving trajectory | = | = |
| Driving homogeneity | = | = |

From the evaluations given in Tables 6 and 7 it can clearly be seen that the tyre according to the invention allowed to achieve the desired two-fold objective of improving and keeping constant for as long a time as possible the handling performance and performance of the tyre in “hot” use conditions without penalizing the handling and road holding 5 performance in the aforementioned “cold” use conditions of the tyre.

Surprisingly, the effect of improving and maintaining over time the handling and performance of the tyre in “hot” use conditions has been achieved despite the use of a “soft” vulcanized elastomeric material in the radially inner portion of the tread band, apparently less suitable for this type of driving condition.

During the tests carried out it was also noted with the tyres according to the invention that there were significant reductions in the lap times on the test circuit.

Various modifications can be made to the embodiments described in detail, still remaining within the scope of protection of the invention, defined by the following claims.

1-22. (canceled)

23. A motorcycle tyre comprising an equatorial plane (X-X) and a tread band comprising:
a) a radially outer portion comprising:
a1) a central sub-portion arranged astride of the equatorial plane (X-X) of the tyre and made with a first vulcanized elastomeric material, and
a2) a pair of lateral sub-portions, distal with respect to the equatorial plane (X-X) of the tyre and arranged on opposite sides of the central sub-portion, wherein the lateral sub-portions are made with a second vulcanized elastomeric material;
wherein the first vulcanized elastomeric material of the central sub-portion has a dynamic elastic modulus (E′) measured at a frequency of 10 Hz and at 23° C. greater than the dynamic elastic modulus (E′) measured at a frequency of 10 Hz and at 23° C. of the second vulcanized elastomeric material of the lateral sub-portions;
wherein the first vulcanized elastomeric material of the central sub-portion and the second vulcanized elastomeric material of the lateral sub-portions have a respective dynamic elastic modulus (E′) measured at a frequency of 10 Hz and at 23° C. ranging from 5.2 MPa to 6.5 MPa;
b) a radially inner portion extending below the radially outer portion of the tread band and along the entire axial development thereof, wherein the radially inner portion is made with a third vulcanized elastomeric material having a dynamic elastic modulus (E′) measured at a frequency of 10 Hz and at 23° C. lower than the dynamic elastic modulus (E′), measured at a frequency of 10 Hz and at 23° C., of the first vulcanized elastomeric material of the central sub-portion of the radially outer portion of the tread band and of the second vulcanized elastomeric material of the lateral sub-portions of the radially outer portion of the tread band;
wherein a ratio R1 between the dynamic elastic modulus (E′) of the second vulcanized elastomeric material of the lateral sub-portions of the radially outer portion of the tread band, measured at a frequency of 10 Hz and at 100° C., and the dynamic elastic modulus (E′) of the third vulcanized elastomeric material of the radially inner portion of the tread band, measured at a frequency of 10 Hz and at 70° C., ranges from 0.8 to 1.2; and
wherein a ratio R2 between the tandelta of the second vulcanized elastomeric material of the lateral sub-portions of the radially outer portion of the tread band, measured at a frequency of 10 Hz and at 100° C., and the tandelta of the third vulcanized elastomeric material of the radially inner portion of the tread band, measured at a frequency of 10 Hz and at 70° C., ranges from 0.8 to 1.2.

24. The motorcycle tyre according to claim 23, wherein the first vulcanized elastomeric material of the central sub-portion of the radially outer portion of the tread band has a dynamic elastic modulus (E′), measured at a frequency of 10 Hz and at 70° C., ranging from 5.1 MPa to 5.5 MPa.

25. The Motorcycle tyre according to claim 23, wherein the first vulcanized elastomeric material of the central sub-portion of the radially outer portion of the tread band has a tandelta, measured at a frequency of 10 Hz and at 70° C., ranging from 0.26 to 0.30.

26. The motorcycle tyre according to claim 23, wherein the second vulcanized elastomeric material of the lateral sub-portions of the radially outer portion of the tread band has a dynamic elastic modulus (E′), measured at a frequency of 10 Hz and at 100° C., ranging from 2.5 MPa to 2.9 MPa.

27. The motorcycle tyre according to claim 23, wherein the second vulcanized elastomeric material of the lateral sub-portions of the radially outer portion of the tread band has a tandelta, measured at a frequency of 10 Hz and at 100° C., ranging from 0.24 to 0.28.

28. The motorcycle tyre according to claim 23, wherein the third vulcanized elastomeric material of the radially inner portion of the tread band has a dynamic elastic modulus (E′), measured at a frequency of 10 Hz and at 70° C., ranging from 2.5 MPa to 2.9 MPa.

29. The motorcycle tyre according to claim 23, wherein the third vulcanized elastomeric material of the radially inner portion of the tread band has a tandelta, measured at a frequency of 10 Hz and at 70° C., ranging from 0.25 MPa to 0.29 MPa.

30. The motorcycle tyre according to claim 23, wherein the first vulcanized elastomeric material of the central sub-portion of the radially outer portion of the tread band has a dynamic elastic modulus (E′), measured at a frequency of 10 Hz and at 23° C., ranging from 6.0 MPa to 6.5 MPa.

31. The motorcycle tyre according to claim 23, wherein the first vulcanized elastomeric material of the central sub-portion of the radially outer portion of the tread band has a tandelta, measured at a frequency of 10 Hz and at 23° C., ranging from 0.40 to 0.44.

32. The motorcycle tyre according to claim 23, wherein the second vulcanized elastomeric material of the lateral sub-portions of the radially outer portion of the tread band has a dynamic elastic modulus (E′), measured at a frequency of 10 Hz and at 23° C., ranging from 5.5 MPa to 6.0 MPa.

33. The motorcycle tyre according to claim 23, wherein the second vulcanized elastomeric material of the lateral sub-portions of the radially outer portion of the tread band has a tandelta, measured at a frequency of 10 Hz and at 23° C., ranging from 0.66 to 0.70.

34. The motorcycle tyre according to claim 23, wherein the third vulcanized elastomeric material of the radially inner portion of the tread band has a dynamic elastic modulus (E′), measured at a frequency of 10 Hz and at 23° C., ranging from 4.0 MPa to 5.0 MPa.

35. The motorcycle tyre according to claim 23, wherein the third vulcanized elastomeric material of the radially inner portion of the tread band has tandelta, measured at a frequency of 10 Hz and at 23° C., ranging from 0.49 MPa to 0.53 MPa.

36. The motorcycle tyre according to claim 23, wherein a ratio R3 between the tandelta of the first vulcanized elastomeric material of the central sub-portion of the radially outer portion of the tread band, measured at a frequency of 10 Hz and at 70° C., and the tandelta of the third vulcanized elastomeric material of the radially inner portion of the tread band, measured at a frequency of 10 Hz and at 70° C., ranges from 0.5 to 1.2.

37. The motorcycle tyre according to claim 23, wherein a ratio R4 between the dynamic elastic modulus (E′) of the first vulcanized elastomeric material of the central sub-portion of the radially outer portion of the tread band, measured at a frequency of 10 Hz and at 70° C., and the dynamic elastic modulus (E′) of the third vulcanized elastomeric material of the radially inner portion of the tread band, measured at a frequency of 10 Hz and at 70° C., ranges from 1.3 to 2.0.

38. The motorcycle tyre according claim 23, wherein a ratio R5 between the dynamic elastic modulus (E′) of the second vulcanized elastomeric material of the lateral sub-portions of the radially outer portion of the tread band, measured at a frequency of 10 Hz and at 23° C., and the dynamic elastic modulus (E′) of the third vulcanized elastomeric material of the radially inner portion of the tread band, measured at a frequency of 10 Hz and at 23° C., ranges from 1.1 and 1.6.

39. The motorcycle tyre according to claim 23, wherein a ratio R6 between the tandelta of the second vulcanized elastomeric material of the lateral sub-portions of the radially outer portion of the tread band, measured at a frequency of 10 Hz and at 23° C., and the tandelta of the third vulcanized elastomeric material of the radially inner portion of the tread band, measured at a frequency of 10 Hz and at 23° C., ranges from 1.1 to 1.6.

40. The motorcycle tyre according to claim 23, wherein a ratio R7 between the dynamic elastic modulus (E′) of the first vulcanized elastomeric material of the central sub-portion of the radially outer portion of the tread band, measured at a frequency of 10 Hz and at 23° C., and the dynamic elastic modulus (E′) of the third vulcanized elastomeric material of the radially inner portion of the tread band, measured at a frequency of 10 Hz and at 23° C., ranges from 1.2 to 1.8.

41. The motorcycle tyre according to claim 23, wherein a ratio R8 between the tandelta of the first vulcanized elastomeric material of the central sub-portion of the radially outer portion of the tread band, measured at a frequency of 10 Hz and at 23° C., and the tandelta of the third vulcanized elastomeric material of the radially inner portion of the tread band, measured at a frequency of 10 Hz and at 23° C., ranges from 0.6 to 1.1.

42. The motorcycle tyre according to claim 23, wherein a ratio R9 between the dynamic elastic modulus (E′) of the third vulcanized elastomeric material of the radially inner portion of the tread band, measured at a frequency of 10 Hz and at 23° C., and the dynamic elastic modulus (E′) of this same vulcanized elastomeric material, measured at a frequency of 10 Hz and at 70° C., ranges from 1.2 to 2.0.

43. The motorcycle tyre according to claim 23, wherein a ratio R10 between the tandelta of the third vulcanized elastomeric material of the radially inner portion of the tread band, measured at a frequency of 10 Hz and at 23° C., and the tandelta of this same vulcanized elastomeric material, measured at a frequency of 10 Hz and at 70° C., ranges from 1.5 and 2.4.

44. The motorcycle tyre according to claim 23, wherein the tyre has a transverse curvature ratio equal to or greater than about 0.30.

45. The motorcycle tyre according to claim 44, wherein the transverse curvature ratio ranges from 0.30 to 0.35.
